(19) United States
(12) Patent Application Publication
(10) Pub. No.: US 2026/0195289 A1
(43) Pub. Date: Jul. 9, 2026

(54) DATA TRANSFER METHOD ON AN SPI LINK WITH THREE WIRES

(71) Applicant: STMicroelectronics International N.V., Geneva (CH)

(72) Inventor: Jean-Marc GENTIT, Herbeys (FR)

(73) Assignee: STMicroelectronics International N.V., Geneva (CH)

(21) Appl. No.: 19/436,298

(22) Filed: Dec. 30, 2025

(30) Foreign Application Priority Data
Jan. 9, 2025 (EP) 25315009.8
Jul. 1, 2025 (FR) FR2507442

(51) Int. Cl. G06F 13/42

(52) U.S. Cl. CPC G06F 13/4282; G06F 2213/0012

(57) ABSTRACT

An SPI link includes three wires between a master circuit and a slave circuit. Data are transferred in packets, each packet including a payload and a header specifying the length of the payload of the packet. During a data transfer between the master and slave circuits, the master circuit defines a number N of bytes to be transferred. The master circuit then determines, after a transfer of N bytes from the master circuit to the slave circuit and a transfer of N bytes from the slave circuit to the master circuit, a number of bytes remaining to be transferred from the slave circuit to the master circuit. This determination is made by the master circuit by reading a value of a length of the payload included in the header of a data packet transferred from the slave circuit to the master circuit.

### PRIORITY CLAIM

This application claims the priority benefit of European Application for Patent No. 25315009.8, filed on January 9, 2025, and claims the priority benefit of French Application for Patent No. FR2507442, filed on July 1, 2025, the contents of which are hereby incorporated by reference in their entireties to the maximum extent allowable by law.

### TECHNICAL FIELD

The present disclosure generally concerns the field of communication protocols and data transfers over a serial peripheral interface (SPI) link.

### BACKGROUND

An SPI link, or bus, is a serial data bus used to transfer data between a master circuit and one or more slave circuits. This type of link uses a synchronous serial communication protocol and is used, in particular, for communications over short distances, for example in embedded systems. Such a link can be used, for example, to couple a microcontroller to peripheral circuits such as sensors or memory devices. For example, with such an SPI link, memory accesses can be direct (for example, using Direct Memory Access (DMA)), which limits, for example, the impact of data exchanges performed with a computing microprocessor of a system provided with such an SPI link.

Data transfer over an SPI bus is achieved by using four logic signals, each transmitted over a wire of the bus which is specific thereto: a Master Output, Slave Input (MOSI) signal, used for the transfer of data from the master circuit to the slave circuit; a Master Input, Slave Output (MISO) signal, used for the transfer of data from the slave circuit to the master circuit; a Serial Clock (SCLK) signal, corresponding to a clock signal generated by the master circuit and used in particular to clock data transfers between the master and slave circuits; and a Slave Select (SS) signal, corresponding to a slave circuit selection signal and which is generated by the master circuit.

In the communication protocol used over an SPI link, the data are sent in packets, each comprising a payload, that is, the information which is desired to be transmitted, and control data. Data transmission in packets particularly enables to preserve a good integrity of the transmitted data, to facilitate error detection, and to have a good data transmission efficiency.

For a use in an embedded system, a number of constraints need to be taken into account, such as:

energy consumption: an embedded system generally operates in an environment constrained in terms of energy consumption, such as when powered by a battery. An effective management of energy use during data transfers performed by the embedded system is important to maintain as much as possible a good lifetime of the battery or batteries, and ensure a reliable operation of the system; and

control of the integrity of the transferred data: data flows between circuits need to be managed in such a way as to decrease or prevent as much as possible the loss or damage of the transferred data. Such a management is particularly important when the transmission rates and/or circuit processing capacities are variable.

Now, a conventional SPI link is not the most suitable type of link for meeting such constraints. In addition, a conventional SPI link is not optimized to perform a simultaneous bidirectional data transfer, which leads to inefficiency and latency. Further, the protocol used over an SPI link lacks robustness, in particular with regard to error management mechanisms, which can lead to poor data integrity.

FIG. 1 shows an example of half-duplex, or semi-duplex, data transmission performed over an SPI link between a master circuit and a slave circuit. In this drawing, reference 10 designates control data transmitted by the master circuit upstream of a transmission of a data packet, designated with reference 12, comprising a payload to be sent from the master circuit to the slave circuit. Reference 14 designates control data transmitted by the master circuit upstream of a data transmission, designated by reference 16, comprising a payload to be sent from the slave circuit to the master circuit. The sending of these data is clocked by a clock signal 18. In this drawing, signal SS is not shown. In such a transmission, the non-simultaneity of the transmission of the data from the master circuit to the slave circuit and that of the data from the slave circuit to the master circuit results in a loss of bandwidth and in an increase in the latency of the system.

FIG. 2 shows an example of full-duplex transmission, carried out on an SPI link between a master circuit and a slave circuit, using fixed time slots. Such a full-duplex communication allows simultaneous transmission and reception of data between the master and slave circuits, thereby improving the efficiency and the speed of communications with respect to a half-duplex transmission. However, the system is, in this case, continuously sending and receiving data of the slot size between the master and slave circuits, regardless of whether payloads are present in the transmitted data packets. In FIG. 2, reference 20 designates data packets comprising a payload, and reference 22 designates data packets comprising no payload. Further, in this drawing, the SS signal is not shown. This approach increases the transmission latency of the system and requires a waiting time at the beginning of each slot to send useful data.

There exists a need to provide a method of data transfer over an SPI link which does not have at least some of the disadvantages of existing solutions.

There is a need to overcomes all or part of the disadvantages of known solutions and provide a method of data transfer over a link of serial peripheral interface (SPI) type.

### SUMMARY

An embodiment provides a method of data transfer over a link of serial peripheral interface (SPI) type with three wires between at least one master circuit and at least one slave circuit, wherein: the data are transferred in packets, each comprising a payload and a header specifying the length of the payload of the packet, and during a data transfer between the master and slave circuits, the master circuit defines a number N of bytes to be transferred, then determines, after a transfer of N bytes from the master circuit to the slave circuit and of N bytes from the slave circuit to the master circuit, a number of bytes remaining to be transferred from the slave circuit to the master circuit based on a value of the length of the payload included in the header of at least one data packet transferred from the slave circuit to the master circuit, this value being read by the master circuit.

According to a specific embodiment, the number N of bytes is greater than or equal to the number of bytes of the header of one of the data packets.

According to a specific embodiment, during a transfer initiated by the master circuit, from the master circuit to the slave circuit, of at least a first data packet having a non-zero payload, the number N of bytes is defined as being equal to the total length of the first data packet.

According to a specific embodiment, during the transfer of the first data packet, if the payload of at least a second data packet, transferred from the slave circuit to the master circuit in parallel with the first data packet, comprises a number of bytes smaller than that of the payload of the first data packet, the slave circuit adds null bytes to the payload of the second data packet so that the total length of the second data packet is equal to the total length of the first data packet.

According to a specific embodiment, during the transfer of the first data packet, if the payload of a second data packet, transferred from the slave circuit to the master circuit in parallel with the first data packet, comprises a number of bytes greater than that of the payload of the first data packet, the master circuit adds null bytes to the payload of the first data packet such that the total length of the first data packet is equal to the total length of the second data packet.

According to a specific embodiment, the transfer of the first data packet is initiated by the master circuit by sending a wake-up signal to the slave circuit, and the first data packet is transferred after the reception, by the master circuit, of an acknowledgment signal sent by the slave circuit as a response to the reception of the wake-up signal.

According to a specific embodiment, during a transfer initiated by the slave circuit, from the slave circuit to the master circuit, of a third data packet having a non-zero payload, the number N of bytes is defined as being equal to the number of bytes of the header of one of the data packets or equal to the total length of a fourth data packet transferred from the master circuit to the slave circuit in parallel with the third data packet.

According to a specific embodiment, during the transfer of the third data packet, if the payload of a fourth data packet, transferred from the master circuit to the slave circuit in parallel with the third data packet, comprises a number of bytes smaller than that of the payload of the third data packet, the master circuit adds null bytes to the payload of the fourth data packet such that the total length of the fourth data packet is equal to the total length of the third data packet.

According to a specific embodiment, during the transfer of the third data packet, if the payload of a fourth data packet, transferred from the master circuit to the slave circuit in parallel with the third data packet, comprises a number of bytes greater than that of the payload of the third data packet, the slave circuit adds null bytes to the payload of the third data packet such that the total length of the third data packet is equal to the total length of the fourth data packet.

According to a specific embodiment, the transfer of the third data packet is initiated by the slave circuit by sending a wake-up signal to the master circuit, and the third data packet is then transferred.

According to a specific embodiment, prior to a data transfer between the master and slave circuits, the slave circuit is configured so that it can receive a data packet having a total length equal to a predefined maximum length of a data packet.

According to a specific embodiment, the data transfer between the master and slave circuits is synchronized by a clock signal sent by the master circuit over a first of the three wires, the data transfer from the master circuit to the slave circuit is performed over a second of the three wires, and the data transfer from the slave circuit to the master circuit is performed over a third of the three wires.

According to a specific embodiment, the header of each data packet comprises at least a robustness field and a field of identification of the protocol type, and/or each data packet comprises a footer field.

There is also provided an electronic circuit comprising at least one serial peripheral interface, configured to implement the data transfer method.

There is also provided an electronic system comprising a plurality of electronic circuits according to the claim and coupled together by at least one SPI-type bus.

The terms "first," "second," "third," and "fourth" indicated hereabove do not imply an order of transmission of these data packets.

### BRIEF DESCRIPTION OF THE DRAWINGS

These features and advantages, as well as others, will be described in detail in the following description of specific embodiments, which is provided by way of example and is not intended to be limiting, in connection with the accompanying drawings, in which:

FIG. 1 shows an example of half-duplex data transfer over an SPI link between master and slave circuits;

FIG. 2 shows an example of full-duplex data transfer over an SPI link between master and slave circuits, using fixed time intervals for the sending of the data packets;

FIG. 3 schematically shows an example of an electronic system comprising electronic circuits coupled together by an SPI link;

FIG. 4 schematically shows an example of a data packet used by a method of data transfer over an SPI link;

FIG. 5 shows examples of signals transmitted during the implementation of the method of data transfer over an SPI link during a data packet transmission initiated by the master circuit;

FIG. 6 shows examples of signals transmitted during the implementation of the method of data transfer over an SPI link during a data packet transmission initiated by the slave circuit;

FIG. 7 shows, in the form of a flowchart, an example of steps implemented by a master circuit during a method of data transfer over an SPI link;

FIG. 8 shows, in the form of a flowchart, an example of steps implemented by a slave circuit during a method of data transfer over an SPI link; and

FIGS. 9, 10, 11, and 12 show examples of data transfers obtained by the implementation of a method of data transfer over an SPI link.

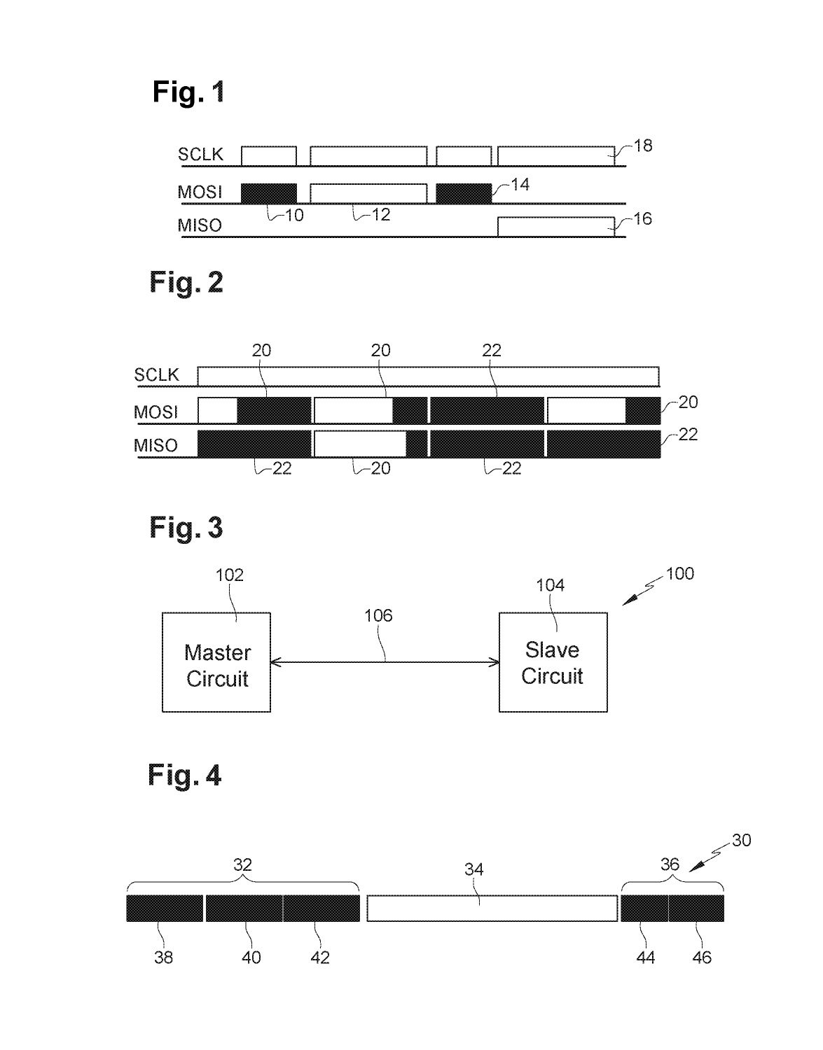

### DETAILED DESCRIPTION

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail. In particular, various elements such as the circuits and the SPI link, various implemented steps, and the coding necessary for the implementation of these steps are not detailed. Those skilled in the art will be capable of forming in detailed fashion these elements based on the functional description given herein.

Unless otherwise specified, when reference is made to two elements being connected to each other, this means directly connected without any intermediate elements other than conductors, and when reference is made to two elements being coupled to each other, this means that these two elements may be connected or may be connected via one or more other elements. Further, the terms "coupled," "linked," and "connected" are here used to designate electrical couplings, links, or connections.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10%, preferably of plus or minus 5%.

Similarly, unless otherwise specified, the indicated ranges of values include the limits of these ranges.

FIG. 3 schematically shows an example of an electronic system 100 in which a method of data transfer over an SPI link according to a specific embodiment is implemented. Electronic system 100 comprises a plurality of electronic circuits 102, 104, each comprising a serial peripheral interface and coupled to each other by at least one SPI-type bus 106. Each of the electronic circuits 102, 104 comprises at least one serial peripheral interface enabling to implement the data transfer method. Bus 106, that is, the SPI link of electronic system 100, comprises three wires, over each of which a specific signal is intended to be transmitted. In the example of FIG. 3, a first electronic circuit, for example a host microcontroller, forms a master circuit 102 coupled by bus 106 to a second electronic circuit, for example a coprocessor, forming a slave circuit 104.

In the configuration described herein, the data transfer between the master and slave circuits 102, 104 is synchronized by a clock signal sent by the master circuit 102 over a first of the three wires, which corresponds to the SCLK signal. The data transfer from the master circuit 102 to the slave circuit 104 is performed over a second of the three wires and which corresponds to the MOSI signal, and the data transfer from the slave circuit 104 to the master circuit 102 is performed over a third of the three wires, which corresponds to the MISO signal.

The implemented data transfer method is of full-duplex type. Thus, the master circuit 102 and the slave circuit 104 simultaneously perform transmissions of data packets over two separate wires of bus 106. The data transfer method is implemented by using three different signals: MOSI, MISO, and SCLK, each of these signals being transmitted over one of the three wires of bus 106.

In the implemented data transfer method, the data are transferred in packets, each packet comprising a payload and a header specifying at least the length of the payload of the packet.

FIG. 4 shows an example of a data packet structure 30 which corresponds, in the described example, to the form in which data are transferred between circuits 102, 104. As a variant, the data packets transferred between circuits 102 and 104 may have a structure different from this one.

In the example of FIG. 4, data packet 30 comprises a header 32, a payload 34, and a footer field 36. In this example, header 32 comprises one or more bytes 38 forming a so-called “magic code”, one or more bytes 40 specifying the length of payload 34, and one or more bytes 42 forming a protocol type identifier and allowing a use of the transfer method with different higher-level protocols and, for example, allowing a routing of data packet 30 to different recipients. As a variant, header 32 may comprise a structure different from that of the example of FIG. 4. Generally, header 32 comprises control data used for the routing of payload 34 to the recipient, such as for example: magic number, protocol type identifier, checksum, etc. According to a specific example, the header 32 of each data packet 30 comprises at least one robustness field and a protocol type identification field, and/or each data packet 30 comprises a footer field 36.

In the example of FIG. 4, footer field 36 comprises one or more stuffing bytes 44 and one or more bytes 46 forming a magic number. As a variant, footer field 36 may comprise a structure different from that of the example of FIG. 4.

The total length of packet 30 corresponds to the sum of the lengths of header 32, payload 34, and footer field 36. According to an embodiment, the total length of packet 30 is equal to a multiple of 32 bits, which facilitates the implementation of a DMA-type transfer.

According to a specific example of implementation, the maximum length of the payload 34 of each packet 30 can be defined at the time of a compilation implemented prior to the data transfer method. For example, the maximum length of payload 34 may be 2 kb. This maximum length may be used to limit the memory footprint in circuits 102, 104 by sizing the buffers used to an appropriate size.

In addition, in each data packet transferred between circuits 102 and 104, payload 34 may comprise useful data bytes intended to be transferred from one circuit to the other and/or dummy bytes. These dummy bytes are used in particular to solve possible alignment problems which would prevent circuits 102, 104 from performing direct memory accesses (DMAs) to send or receive data. According to a specific example of embodiment, the length of header 32 may be fixed and identical for all packets 30, regardless of the length of the payload 34 of each packet 30.

In the described transfer method, the MOSI and MISO signals, transmitted over two separate wires of bus 106, are used, in particular, for the transfer of data packets 30 intended to be exchanged between the master circuit 102 and the slave circuit 104, and also for the transport of control signals exchanged between circuits 102, 104 prior to the transfer of data packets 30. Such control signals correspond, for example, to wake-up signals and/or acknowledgment signals exchanged between circuits 102, 104. For example, when the master circuit 102 wishes to send data to the slave circuit 104, the master circuit 102 may generate a pulse over the MOSI signal wire, used as a signal for waking up the slave circuit 104. Then, when the slave circuit 104 is ready for data transfer with the master circuit 102, the slave circuit 104 may generate a pulse on the MISO signal wire to inform the master circuit 102 of its ready-to-receive status, this pulse being used as an acknowledgment signal sent as a response to the reception of the wake-up signal.

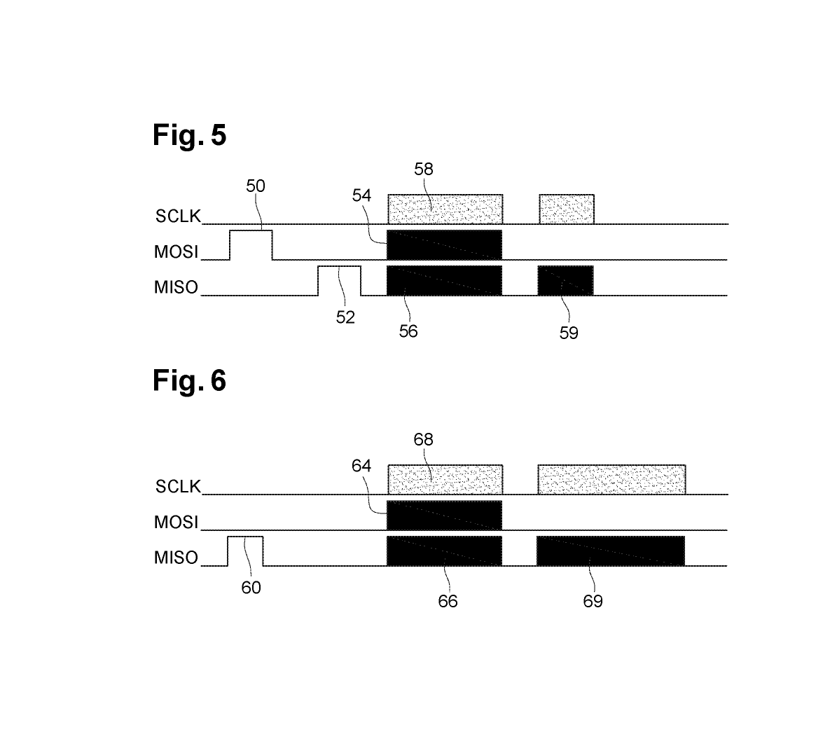

FIG. 5 shows examples of signals transmitted during the implementation of the data transfer method during a sending of at least one data packet 30, initiated by the master circuit 102.

In this example, the master circuit 102 first sends a wake-up signal 50, for example in the form of a pulse, over the MOSI signal wire in order to wake up the slave circuit 104. On reception of this wake-up signal 50, and when the slave circuit 104 is ready to perform the data transfer, the slave circuit 104 transmits an acknowledgment signal 52 over the MISO signal wire to the master circuit 102 to inform it that it is ready for the data transfer.

The data transfer is then performed between the master and slave circuits 102, 104, over the MOSI and MISO signal wires. N data bytes 54, forming one or more data packets 30, are transferred over the MOSI signal line from the master circuit 102 to the slave circuit 104. In parallel, that is, simultaneously with the sending of data 54, N data bytes 56, forming one or more other data packets 30, are transferred over the MISO signal line from the slave circuit 104 to the master circuit 102. The value of N is defined by the master circuit 102 prior to the exchange of data packets 30 between the master and slave circuits 102, 104.

During this transfer of data 54, 56, if the slave circuit 104 has fewer data to transmit than the master circuit 102, the slave circuit 104 may supplement the payload 34 of the data packet(s) 30 sent to the master circuit 102 with null bytes, so that the total number of bytes sent to the master circuit 102 is equal to N. In other words, if the payload of at least one data packet intended to be transferred from the slave circuit 104 to the master circuit 102 comprises a number of bytes smaller than that of the payload of the data packet(s) to be transferred from the master circuit 102 to the slave circuit 104, the slave circuit 104 may add null bytes to be transmitted to the master circuit 102 so that the amount of data 56 is equal to the amount of data 54. Further, in the absence of data to be transmitted from the slave circuit 104 to the master circuit 102, the payload of the packet(s) forming data 56 may comprise null bytes only.

The transfer of data 54, 56 is clocked by a clock signal 58 transmitted over the SCLK signal wire.

After the transfer of data packets 54, 56, the master circuit 102 determines a number of bytes remaining to be transferred from the slave circuit 104 to the master circuit 102 based on the value of the length of the payload 34 included in the header 32 of the packet(s) 30 corresponding to the data 56 transferred from the slave circuit 104 to the master circuit 102, this value being read by the master circuit 102. In the example of FIG. 5, after the transfer of data 54, 56, there are remaining bytes to be transferred from the slave circuit 104 to the master circuit 102. These remaining bytes, designated by reference 59, are then transferred over the MISO signal wire from the slave circuit 104 to the master circuit 102, this transmission being clocked by clock signal 58. Further, in this example, in parallel with the sending of these remaining bytes 59, the master circuit 102 may send data which are ignored by the slave circuit 104.

The value of number N, which is determined by the master circuit 102, is greater than or equal to the number of bytes in the header 32 of one of the data packets 30. In the example of FIG. 5, which corresponds to a data transfer initiated by the master circuit 102 to send data to the slave circuit 104 which correspond to at least a first data packet 30 having a non-null payload 34, number N is defined as being equal to the total length of the first data packet 30. Thus, in the case of a data transfer initiated by the master circuit 102, the latter performs the transmission of all the data intended for the slave circuit 104, without taking into account the possible data that the slave circuit 104 needs to transmit to the master circuit 102.

FIG. 6 shows examples of signals transmitted during the implementation of the data transfer method during a transmission of at least one data packet 30 initiated by the slave circuit 104.

In this example, the slave circuit 104 first sends a wake-up signal 60, for example in the form of a pulse, over the MISO signal wire in order to wake up the master circuit 102. On reception of this wake-up signal 60, and when the master circuit 102 is ready to perform the data transfer, this transfer is performed between the master and slave circuits 102, 104, over the MOSI and MISO signal wires. N bytes of data 64 are transferred over the MOSI signal line from the master circuit 102 to the slave circuit 104. In parallel, that is, simultaneously with the sending of data 64, N bytes of data 66 are transferred over the MISO signal line from the slave circuit 104 to the master circuit 102. As in the previous example of FIG. 5, the value of N is defined by the master circuit 102 prior to the exchange of data 64, 66 between the master and slave circuits 102, 104. The transfer of data 64, 66 is triggered by the master circuit 102 via the generation of a clock signal 68 over the SCLK signal wire.

After the transfer of data 64, 66, the master circuit 102 determines a number of bytes remaining to be transferred from the slave circuit 104 to the master circuit 102 based on the value of the length of the payload 34 included in the header 32 of the packet(s) 30 corresponding to the data 66 transferred from the slave circuit 104 to the master circuit 102, this value being read by the master circuit 102. In the example of FIG. 6, after the transfer of data 64, 66, there are remaining bytes to be transferred from the slave circuit 104 to the master circuit 102. These remaining bytes, designated by reference 69, are then transferred over the MISO signal wire from the slave circuit 104 to the master circuit 102, this transmission being clocked by clock signal 68. Further, in this example, in parallel with the sending of these remaining bytes 69, the master circuit 102 may send data which are ignored by the slave circuit 104.

In the example of FIG. 6, which corresponds to a data transfer initiated by the slave circuit 104 for the sending of data to the master circuit 102, number N is defined, for example, as being equal to the number of bytes of the header 32 of a data packet 30. Such a definition of the value of N is particularly relevant when the master circuit 102 has no data to transfer to the slave circuit 104. Thus, in this example of data transfer initiated by the slave circuit 104, the master circuit 102 defines the value of N such that only the header 32 of a data packet 30 is exchanged between the master and slave circuits 102, 104. Then, the number of bytes remaining to be transferred from the slave circuit 104 to the master circuit 102 is read by the master circuit 102 (due to the fact that the header 32 transferred to the master circuit 102 contains the length, that is, the number of bytes, of the data that the slave circuit 104 must transmit to the master circuit 102), after which a transfer of this number of remaining bytes is performed.

According to a variant, when the master circuit 102 comprises data to be transmitted to the slave circuit 104 but the transfer is initiated by the slave circuit 104, number N may be defined as being equal to the total length of the data packet to be transmitted to the slave circuit 104. Then, as previously, after the transfer of data 64, 66, the number of bytes remaining to be transferred from the slave circuit 104 to the master circuit 102 is read by the master circuit 102, after which a transfer of this number of remaining bytes is optionally performed.

According to another variant, the value of N may be determined differently from the previous examples. Thus, in the case of a transfer initiated by the slave circuit 104, the value of N may be determined heuristically, for example based on previous values of N determined during previous data transfers between the slave circuit 104 and the master circuit 102, and by selecting a minimum value from among these previous values of N. According to another example, it is possible to use more complex prediction systems.

In a specific example of embodiment, prior to a data transfer between the master and slave circuits 102, 104, the slave circuit 104 may be configured so that it can receive at least one data packet having a total length equal to a predefined maximum length.

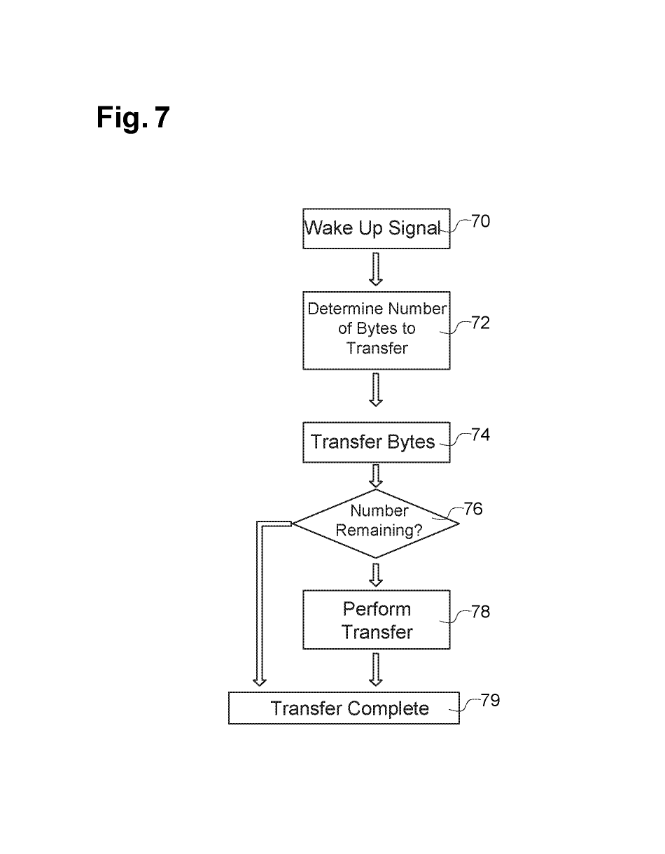

FIG. 7 shows an example of steps implemented by the master circuit 102 during a method of data transfer between the master and slave circuits 102, 104.

In a first step 70, a data transfer is initiated either by the master circuit 102 via the transmission of a wake-up signal over the MOSI signal wire, as in the example of FIG. 5, or by the slave circuit 104 via the transmission of a wake-up signal over the MISO signal wire, as in the example in FIG. 6. In the case of a transfer initiated by the master circuit 102, the latter waits for the response of the slave circuit 104, that is, the sending of an acknowledgment signal over the MISO signal wire.

In a second step 72, the master circuit 102 determines the value of parameter N, that is, the number of bytes to be transferred between the master and slave circuits 102, 104. When the transfer is initiated by the master circuit 102, the value of N may be defined as being equal to the size of the data packet(s) 30 to be transmitted to the slave circuit 104 by the master circuit 102. When the transfer is initiated by the slave circuit 104, the value of N can be defined as equal to the size of a header 32 of a data packet 30.

In a third step 74, N bytes are transferred from the master circuit 102 to the slave circuit 104 (corresponding to data 54 and 64 in the previous examples), and N bytes are transferred from the slave circuit 104 to the master circuit 102 (corresponding to data 56 and 66 in the previous examples). In all cases, the master circuit 102 receives at least the header 32 of a data packet 30 sent by the slave circuit 104.

In a fourth step 76, the master circuit 102 determines a number of bytes remaining to be transferred from the slave circuit 104 to the master circuit 102 based on the value of the length of the payload 34 included in the header 32 transferred from the slave circuit 104 to the master circuit 102, and on the previously-determined value of N.

If there remain data to be transferred from the slave circuit 104 to the master circuit 102, then this transfer is performed (step 78). Otherwise, the transfer is considered as being complete (step 79).

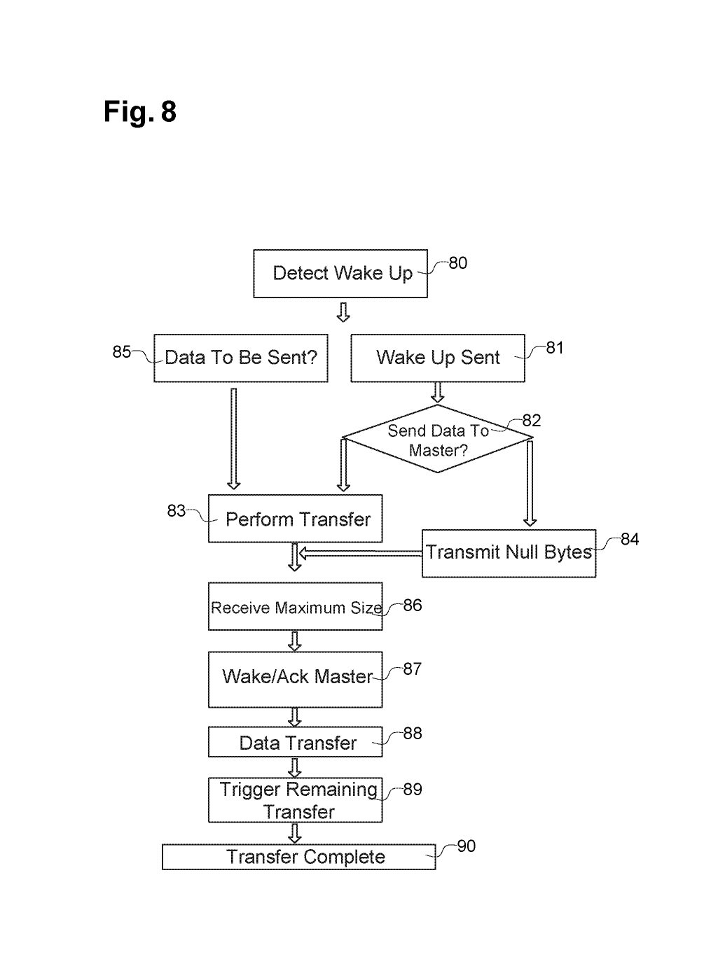

FIG. 8 shows an example of steps implemented by the slave circuit 104 during a method of data transfer between the master and slave circuits 102, 104.

During a first step 80, the slave circuit 104 is in a configuration of detection of a wake-up signal over the MOSI signal wire.

If the master circuit 102 sends a wake-up signal (step 81), the slave circuit 104 verifies whether data need to be sent to the master circuit 102 (step 82). If so, the slave circuit 104 is then configured to be able to perform the transmission of these data (step 83). If not, the slave circuit 104 is here configured to perform a transmission of null bytes (step 84). Further, before the reception of a wake-up signal, if the slave circuit 104 has data to be sent to the master circuit 102 (step 85), the slave circuit 104 is configured to perform the transmission of these data (step 83) without waiting for the reception of a wake-up signal. In all cases, the slave circuit 104 may be configured so that it is capable of receiving a data packet of maximum size (step 86).

During a subsequent step 87, the slave circuit 104 sends over the MISO signal wire a signal to the master circuit 102, which corresponds either to a signal for waking up the master circuit 102 or to an acknowledgment signal.

The data transfer between the master and slave circuits 102, 104 is then performed (step 88).

If all the data intended for the master circuit 102 have not been transferred, this is detected by the master circuit 102, which then triggers the transfer of the remaining data from the slave circuit 104 to the master circuit 102 (step 89). Step 90 represents the completion of the data transfer between the master and slave circuits 102, 104.

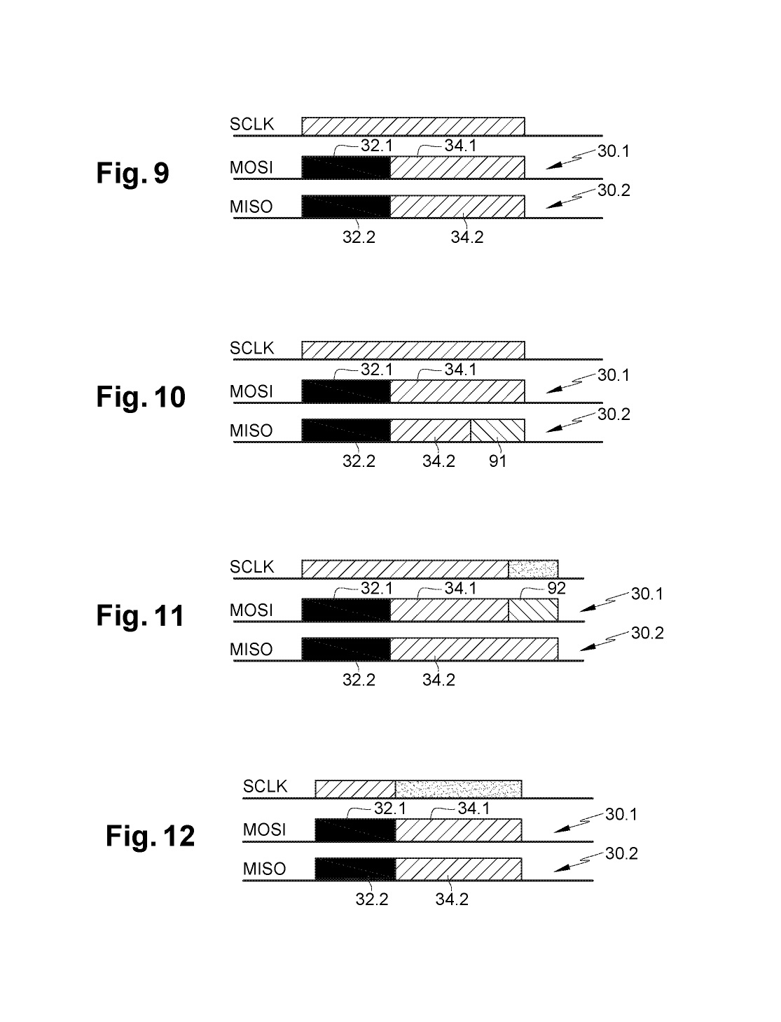

FIG. 9 shows a first example of transfer of data packets 30.1, 30.2 performed between the master circuit 102 and the slave circuit 104. In this example, the data transfer is initiated by the master circuit 102, which comprises a payload 34.1 of TX bytes to be transferred, with TX specified as non-zero in the header 32.1 of the data packet 30.1 sent by the master circuit 102. In this example, the slave circuit 104 comprises no data to be transferred to the master circuit 102. Thus, the header 32.2 of the data packet 30.2 sent by the slave circuit 104 specifies a zero payload length RX (RX designating the number of bytes to be transferred to the master circuit 102), and the payload 34.2 of the data packet 30.2 transferred from the slave circuit 104 to the master circuit 102 comprises null bytes.

FIG. 10 shows a second example of transfer of data packets 30.1, 30.2 between the master circuit 102 and the slave circuit 104. In this second example, the data transfer is initiated either by the master circuit 102, which has a payload 34.1 of TX bytes to be transferred, with TX non-zero, or by the slave circuit 104, which has a payload 34.2 of RX bytes to be transferred, with RX non-zero. In this example, RX < TX, and the payload 34.2 of the data packet 30.2 sent by the slave circuit 104 is supplemented with null bytes designated by reference 91. Thus, in this example, if the payload 34.1 of the data packet 30.1 transferred from the master circuit 102 to the slave circuit 104 in parallel with the data packet 30.2 comprises a number of bytes greater than that of the payload 34.2 of the data packet 30.2, the slave circuit 104 adds null bytes to the payload 34.2 of the data packet 30.2 so that the total length of the data packet 30.2 is equal to that of the data packet 30.1.

FIG. 11 shows a third example of transfer of data packets 30.1, 30.2 between the master circuit 102 and the slave circuit 104. In this third example, the data transfer is initiated either by the master circuit 102, which has a payload of TX bytes to be transferred, with TX non-zero, or by the slave circuit 104, which has a payload of RX bytes to be transferred, with RX non-zero. In this example, TX < RX, and thus the payload 34.1 of the data packet 30.1 sent by the master circuit 102 is supplemented with null bytes 92 after the master circuit 102 has determined the presence of remaining bytes to be transferred from the slave circuit 104. Thus, in this example, if the payload 34.2 of the data packet 30.2 transferred from the slave circuit 104 to the master circuit 102 in parallel with data packet 30.1 has a number of bytes greater than that of the payload 34.1 of data packet 30.1, the master circuit 102 adds null bytes to the payload 34.1 of data packet 30.1 such that the total length of data packet 30.1 is equal to that of data packet 30.2.

FIG. 12 shows a fourth example of transfer of data packets 30.1, 30.2 performed between the master circuit 102 and the slave circuit 104. In this fourth example, the data transfer is initiated by the slave circuit 104, which has a payload of RX bytes to be transferred, with RX non-zero. In this example, the master circuit 102 does not comprise payload data to be transferred to the slave circuit 104. The payload of the data packet 30.2 sent by the master circuit 102 only comprises null bytes 92.

In the various described configurations, the master and slave circuits 102, 104 implement a "handshake" mechanism. In the previously-described examples, this mechanism corresponds to the sending by slave circuit 104 of an acknowledgment signal over the MISO signal wire after the reception of the wake-up signal sent by the master circuit 102 in the case of a transfer initiated by the master circuit 102, or corresponds to the triggering of the transfer by the master circuit 102 after the reception of the wake-up signal sent by the slave circuit 104 in the case of a transfer initiated by the slave circuit 104. Such a mechanism enables to well control the clocking of the data transfers performed between the master and slave circuits 102, 104. In addition, the wake-up signals sent to initiate a data transfer may be used to take out of a stand-by state the circuit receiving this wake-up signal, without for the circuit which sends the wake-up signal to have to know in advance the state of the circuit to which the wake-up signal is sent.

In the various described examples, the lengths of the payload data transmitted between circuits may be adapted by supplementing the payloads with null bytes so that the circuits exchange the same number of bytes. Thus, it is possible to achieve a method of full-duplex data transfer without having to use time intervals of fixed value for the data transfer.

The described transfer method has the advantage of performing a data transfer over an SPI link with only 3 wires, a low power consumption, and a good control of data flows. This method is a very good compromise between implementation complexity and data transfer efficiency. Further, direct transfers performed between circuits, without passing through a central processor, for example, enable to decrease the load of this central processor. Further, the data transfer performed corresponds to a transmission of full duplex type.

The provided method forms a protocol which enables to simultaneously send and receive data. A header containing information relative to the packet size enables to verify whether the received packet is complete and, if necessary, to continue the procedure to recover the missing bytes. A performance improvement mechanism may complete the protocol by systematically transmitting a minimum bytes size, which enables in most cases to receive and transmit an entire message.

The method is also robust and allows a good management of transmission errors. The provided method addresses the constraints imposed on embedded systems well.

The method may be implemented with a direct hardware control or via a real-time operating system.

The transfer method can be implemented in a host processor and a coprocessor which are coupled together by a three-wire SPI link but which may communicate differently with other elements, for example for low-power applications, wireless applications such as Wi-Fi, Bluetooth, 2.4 GHz band, or applications in the field of the Internet of Things (IoT).

The method can be implemented for applications which require efficient communication and optimal power management, particularly in embedded systems, mobile devices, portable technology, IoT, automotive applications, medical devices, consumer electronics, and network equipment.

Various embodiments and variants have been described. The person skilled in the art will understand that certain features of these various embodiments and variants could be combined, and other variants will become apparent to the person skilled in the art.

Finally, the practical implementation of the described embodiments and variants is within the reach of the person skilled in the art on the basis of the functional indications given above.

1. A method of data transfer over a link of serial peripheral interface (SPI) type, said link including three wires between a master circuit and a slave circuit, wherein data are transferred in packets, each packet comprising a payload and a header specifying a length of the payload of the packet, the method comprising:
defining by the master circuit, during a data transfer between the master and slave circuits, a number N of bytes to be transferred; and
then determining, after a transfer of N bytes from the master circuit to the slave circuit and a transfer of N bytes from the slave circuit to the master circuit, a number of bytes remaining to be transferred from the slave circuit to the master circuit based on a value of the length of the payload included in the header of at least one data packet transferred from the slave circuit to the master circuit;
wherein determining comprises reading the value by the master circuit.

2. The method according to claim 1, wherein the number N of bytes is greater than or equal to a number of bytes in the header of one of the data packets.

3. The method according to claim 1, wherein, during a transfer initiated by the master circuit, from the master circuit to the slave circuit, of at least a first data packet having a non-zero payload, the number N of bytes is defined as being equal to a total length of the first data packet.

4. The method according to claim 3, wherein, during the transfer of the first data packet, when the payload of at least a second data packet transferred from the slave circuit to the master circuit in parallel with the first data packet comprises a number of bytes smaller than that of the payload of the first data packet, the method further comprises adding, by the slave circuit, null bytes to the payload of the second data packet such that the total length of the second data packet is equal to the total length of the first data packet.

5. The method according to claim 3, wherein, during the transfer of the first data packet, when the payload of a second data packet transferred from the slave circuit to the master circuit in parallel with the first data packet has a number of bytes greater than that of the payload of the first data packet, the method further comprises adding, by the master circuit, null bytes to the payload of the first data packet such that the total length of the first data packet is equal to the total length of the second data packet.

6. The method according to claim 3, further comprising: initiating transfer of the first data packet by the master circuit by sending a wake-up signal to the slave circuit; and transferring the first data packet after reception, by the master circuit, of an acknowledgment signal sent by the slave circuit as a response to the wake-up signal.

7. The method according to claim 1, wherein, during a transfer initiated by the slave circuit, from the slave circuit to the master circuit, of a third data packet having a non-zero payload, the number N of bytes is defined as being equal to the number of bytes in the header of one of the data packets or equal to the total length of a fourth data packet transferred from the master circuit to the slave circuit in parallel with the third data packet.

8. The method according to claim 7, wherein, during the transfer of the third data packet, when the payload of a fourth data packet transferred from the master circuit to the slave circuit in parallel with the third data packet has a number of bytes smaller than that of the payload of the third data packet, the method further comprises adding, by the master circuit, null bytes to the payload of the fourth data packet such that the total length of the fourth data packet is equal to the total length of the third data packet.

9. The method according to claim 7, wherein, during the transfer of the third data packet, when the payload of a fourth data packet transferred from the master circuit to the slave circuit in parallel with the third data packet has a number of bytes greater than that of the payload of the third data packet, the method further comprises adding, by the slave circuit, null bytes to the payload of the third data packet such that the total length of the third data packet is equal to the total length of the fourth data packet.

10. The method according to claim 7, further comprising: initiating transfer of the third data packet by the slave circuit by sending a wake-up signal to the master circuit; and transferring the third data packet after sending the wake-up signal.

11. The method according to claim 1, further comprising configuring the slave circuit, prior to a data transfer between the master and slave circuits, to receive a data packet having a total length equal to a predefined maximum length of a data packet.

12. The method according to claim 1, further comprising synchronizing data transfer between the master and slave circuits using a clock signal sent by the master circuit over a first of the three wires, and wherein data transfer from the master circuit to the slave circuit is performed over a second of the three wires, and wherein data transfer from the slave circuit to the master circuit is performed over a third of the three wires.

13. The method according to claim 1, wherein the header of each data packet comprises a robustness field and a protocol type identification field.

14. The method according to claim 1, wherein each data packet includes a footer field.

15. An electronic circuit, comprising at least one serial peripheral interface (SPI) configured to implement the method according to claim 1.

16. An electronic system, comprising a plurality of the electronic circuits according to claim 15 and coupled together by at least one SPI-type bus.

17. A method of data transfer over a link of serial peripheral interface (SPI) type, said link including a first wire for data transfer from a master circuit to a slave circuit, a second wire for data transfer from the slave circuit to the master circuit, and a third wire having a clock signal for synchronizing data transfer between the master and slave circuits, the method comprising:
defining by the master circuit a number N of bytes for the data transfer between the master and slave circuits;
performing a synchronized data transfer between the master and slave circuits by:
transferring N bytes from the master circuit to the slave circuit; and
transferring N bytes from the slave circuit to the master circuit;
reading, by the master circuit, a value of a length of a payload included in a header of at least one data packet transferred from the slave circuit to the master circuit during the synchronized data transfer; and
determining a number of bytes remaining to be transferred from the slave circuit to the master circuit based on the read value.
